(19) United States
(12) Patent Application Publication
(10) Pub. No.: US 2010/0169318 A1
(43) Pub. Date: Jul. 1, 2010

(54) CONTEXTUAL REPRESENTATIONS FROM DATA STREAMS

(75) Inventors: Donald Thompson, Sammamish, WA (US); Alexander Sasha Stojanovic, Redmond, WA (US); Alexander Kolmykov-Zotov, Sammamish, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/345,714

(22) Filed: Dec. 30, 2008

(51) Int. Cl. G06F 17/30

(52) U.S. Cl. 707/737; 707/E17.046

(57) ABSTRACT

A user's experience with internet content may be given semantic meaning based upon extracting features of the content and creating kind classifications from the features. Kind classifications may be used to enrich a user's experience with internet content by providing meaningful navigation and discovery of information. As provided herein, a data stream (e.g., HTML, audio, video, unstructured data, etc.) is received, and features (e.g., text, phrases, titles, paragraphs, image data, etc.) may be extracted from the data stream. Kind classifications may be created based upon the extracted features. For example, a shirt image kind classification may be created based upon a button image feature, a collar image feature, and a sleeve image feature. The user's experience may be enriched by a presentation of actions allowing the user to view similar shirts, purchase the shirt, and/or discover other information relating to the shirt, for example.

### BACKGROUND

A user's experience of internet resources may involve navigation and discovery of information. For example, a user may perform a web search that returns hyperlinks to websites the user may find useful. A user's experience may be enhanced by providing more advanced interactions based upon an improved understanding of the user's preferences. For example, if it can be determined a user is interacting with an image of a car, then additional information may be provided (e.g., local car dealership information, current car reviews, etc.). Machine comprehension attempts to understand the user's interactions by reducing a gap between the format of information a human understands and a machine understands.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

A technique for creating contextual representation of a data stream through semantic interpretation is disclosed herein. A data stream is received. The data stream may comprise structured and/or unstructured data. For example, a data stream may comprise HTML images and text from a website a user interacted with, an e-mail received by a user, audio, and/or other formats of data. Metadata may be extracted from the data stream (e.g., shutter speed and resolution of an image). The extracted metadata may be used to create a format table (e.g., store the extracted metadata in persistent storage). The data stream and/or extracted metadata may be identified as a work packet. Non-semantic entities within the work packet may be removed (e.g., links, advertisements, scripts).

At least one feature within the work packet may be extracted. A feature may comprise proper names, text fragments, lists, dates, etc. For example, an image of a shirt may comprise button, collar, and/or sleeve features. At least one kind classification may be created based upon at least one feature. For example, a shirt kind classification may be created based upon the features of a button, collar, and sleeve. A kind classification may comprise a confidence level of the classification, a timestamp, and/or the data stream associated with the kind classification. At least one kind classification and/or an associated set of related information may be presented. For example, if a user interacts with a website regarding a live concert, then the user may be presented with a concert kind classification comprising additional information about the concert, other local concerts, biographical information about the composer, and/or actions the user may perform (e.g., send the concert information to friends, save the date of the concert on a calendar, etc.).

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow chart illustrating an exemplary method of creating at least one semantic context of a data stream.

FIG. 2 is a component block diagram illustrating an exemplary system for creating at least one semantic context of a data stream.

FIG. 3 is an illustration of an example of creating at least one kind classification based upon a data stream comprising HTML representing an image and text of a webpage.

FIG. 4 is an illustration of an example of creating at least one kind classification based upon a data stream comprising HTML representing text of a webpage.

FIG. 5 is an illustration of an example of creating at least one kind classification based upon a data stream comprising text within an e-mail.

FIG. 6 is an illustration of removing at least one duplicate kind classification from a set of kind classifications.

FIG. 7 is an illustration of an exemplary computer-readable medium wherein processor-executable instructions configured to embody one or more of the provisions set forth herein may be comprised.

FIG. 8 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are illustrated in block diagram form in order to facilitate describing the claimed subject matter.

Humans and machines understand and format knowledge and information in different ways. Because of the difference in understanding and format, it may be difficult for a machine to recognize a user's actions and requirements within a digital world, thus hindering the ability to organize and guide the user's interactions. One goal of hosting internet resources (e.g., websites, search engines, web applications, etc.) is to enhance a user's experience in navigation and discovery of information (e.g., return hyperlinks to websites, images, textual information in response to a web search). Because humans and machines do not understand information in a similar manner, it is more difficult for a machine to understand the user's experience. For example, a machine may not be able to recognize the semantic meaning of text, images, and/or other data the user may interact with. The machine may understand an image of a shirt as a set of pixels, whereas a user may understand the image as a shirt that the user may want to purchase.

As set forth herein, a technique for creating contextual representations of a data stream through semantic interpretation is provided. The technique focuses on the user experience rather than current methods of machine comprehension and/or machine to machine comprehension. The technique creates conceptual entities that are human centric from structured and/or unstructured content a user interacts with. For example, content may include a data stream representing video, image, music, text, e-mail, HTML, and/or other data the user interacts with. In one example, an e-mail may comprise a recommendation to see the new action movie produced by John. The data (e.g., text) within the e-mail may be used to extract features from the e-mail. In this example, features may comprise an e-mail, a recommendation, an e-mail with a recommendation, a movie, a movie recommendation, an action movie, John as a producer, and/or other features that may be extracted from the data within the e-mail.

The extracted features may be used to produce kind classifications, which may comprise semantic actions that may be performed based upon the kind classification. Kind classifications may be used to create meaningful patterns and categories from the data the user generates and/or encounters everyday within the digital world. The kind classifications may be stored within persistent storage in a structured manner (e.g., indexed, projected into schema tables, available to third party entities, etc.). The kind classifications may be ranked based upon user preference. The kind classifications, actions the user can do with the kind classifications, and/or other information may be presented. In one example, a search term may be received from a user through a web browser. A set of kind classifications may be determined based upon search results. The user may be presented with similar items that the user may be interested in and/or actions that the user may take upon the similar items. For example, a search term for recommendations may be received from the user. Kind classifications associated with recommendations may be returned to the user (e.g., e-mail recommendations the user recently viewed, recommendations relating to specific topics the user is interested in, the ability to share recommendations with friends within an e-mail contact list, etc.).

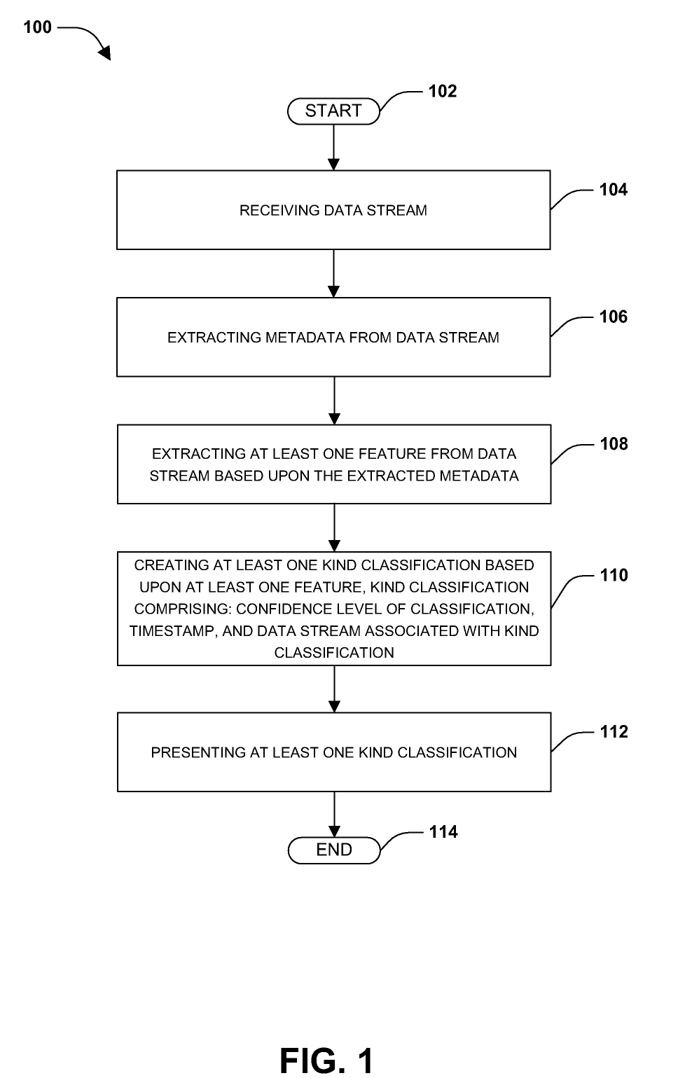

One embodiment of creating at least one semantic context of a data stream is illustrated by an exemplary method 100 in FIG. 1. At 102, the method begins. At 104, a data stream is received. The data stream may comprise audio, visual, textual, structured, and/or unstructured data (e.g., an image file, a selection of text, an audio file, a video file, an e-mail, etc.). In one example, the data stream may comprise HTML data corresponding to a website a user has interacted with through a web browser. At 106, metadata may be extracted from the data stream (e.g., the metadata may be persisted into a format table, stored in a work packet, and/or associated with the data stream). For example, photo metadata may comprise resolution, shutter speed, date, and/or other data. The metadata may be extracted from the data stream for use in creating semantic context of the data stream.

The data stream may be cleansed in one example by removing non-semantic entities from the data stream because they do not comprise useful information in determining kind classifications (e.g., semantic context of data the user interacts with and/or generates). For example, advertisements, scripts, links, tags may not have semantic meaning and are therefore removed. Furthermore, the data stream may be normalized. Normalization allows feature extraction and/or other processing to operate on a single representation. For example, similar document types (e.g., e-mail, web page, PDF, etc.) may be normalized into a single representation.

At 108, at least one feature from the data stream and/or the extracted metadata is extracted. In one example, a data stream may comprise text concerning Action, a movie produced by John. One feature may comprise the text “John produced the movie Action”. To create semantic meaning, the word “produced” may be used to determine that John is a producer of movies and that Action is a movie. Other features of a data stream comprising text may be headings, titles, paragraphs, tables, lists, recognized named entities, and/or recognized phrases. In another example, a data stream may comprise rectangular pixels of an image. Features of the data stream may be edges, a foreground, a background, color, recognized objects within the image (e.g., an ear, an eye, a nose, etc.). These features may be used to create semantic contextual meaning of the rectangular pixels. The features may be used to understand the data stream as an image of a face because a face image comprises the features of an ear, eye, and/or nose (e.g., via the used of facial/image recognition techniques). The image of a face may be used to create a kind classification.

At 110, at least one kind classification (e.g., semantic contextual information of the data stream) is created based upon at least one feature. A kind classification may comprise a confidence level of classification, a timestamp, and/or a data stream associated with the kind classification. Features are used to create kind classifications that comprise those features. Features may be selected and grouped based upon how useful or closely they represent a kind classification. This may help target a useful ontology. For example, text associated with an actor and text associated with a movie may be used to describe the relationship between them. In one example, a feature may comprise a title, “John wrote Apples to Apples”, of a webpage concerning book reviews. The structure of the title may be interpreted as “author” “wrote” “book”. One kind instance may be John as an author. Another kind instance may be Apples to Apples as a book. Kind classification facilitates the analysis, understanding, and/or organization of a user's interaction, thus additional information and/or guidance may be provided to the user based upon the kind classifications.

Because multiple kind classifications may be created based upon a data stream, duplicate kind classifications may be removed. For example, a data stream may comprise HTML of a website. The website may comprise two identical images of a shirt. A first kind classification and a second kind classification may be created based upon the images of the shirt. To avoid duplication, one of the kind classifications may be removed.

It may be appreciated that kind classification may be created through a variety of techniques. For example Support Vector Machines, artificial neural network, and/or other techniques may be employed to classify features into kind classifications. This allows for flexibility by utilizing a variety of techniques for kind classifications.

The kind classifications may be stored in persistent storage. In one example, kind classifications may be stored in persistent storage in a cloud computing environment to improve accessibility. This accessibility may allow future retrieval and/or third parties to utilize the kind classifications. For example, previously created kind classifications may be presented to the user based upon a search relating to those kind classifications (e.g., a user expresses interest in a car and in response previously created kind classifications relating to the user's interest in the car may be returned).

The kind classifications stored in persistent storage may be indexed based upon textual indexing, spatial indexing, temporal indexing, and/or other indexing techniques. For example, a kind classification may correspond to a shirt. A spatial indexing may comprise information about shops selling the shirt within 5 miles of the user. A temporal indexing may comprise events occurring in the last two months relating to the shirt.

A schema may be created and associated with the indexed kind classifications within the persistent storage. The schema may provide a structured representation of the kind classifications. The structured representations may help third party developers understand the kind classifications and/or utilize the kind classifications in a useful manner.

A ranking set comprising an ordered vector of kind classifications may be created based upon at least one user preference. The ranking set may be created in response to a request (e.g., a search, a determination for relatedness) to present results of a kind classification. For example, if a user expresses interest in a musical artist, then kind classifications corresponding to the artist, music created by the artist, an action to sample music created by the artist, and/or other kind classification or actions may be used to create a ranking set. The ranking set may be presented to the user to provide an enriched user experience (e.g., additional information and user guidance may be provided).

At 112, at least one kind classification and/or an associated set of related data may be presented. The associated set of related data may comprise actions that may be performed with kind classifications and/or other additional information that may be useful to a user. The presentation may comprise a ranking set (e.g., an order set of kind classifications ranked based upon user preference). The kind classifications and/or ranking set may be presented within a web browser, a window, a carousel, and/or other means of presenting information such as kind classifications. At 114, the method ends.

It may be appreciated that the technique described in FIG. 1 may reside and execute across a cloud based computing environment. For example, the persistent storage may be comprised within a cloud based computing environment.

In one example of the exemplary method 100, a data stream comprising text may be received. A list of subject matter may be extracted from the text of the data stream. For example, a predication may be made as to the subject matter of the text based upon recognized words and/or phrases. The list of subject matter may be narrowed down to at least one subject (e.g., a kind classification representing a topic within the data stream). Using the subjects as a reference, named entities within the data stream may be extracted. Named entities may be specific text within the data stream that are recognized and may relate to a subject. Named entities may be recognized based upon matching words or phrases within the data stream to a base reference. The named entities may be structured into categories (e.g., kind classifications).

It may be appreciated that the accuracy of creating semantic contexts of a data stream may be improved through the utilization of reference data. For example, a knowledge base concerning music, movies, products, and/or general knowledge may be utilized to determine and recognize features, subjects, and/or kind classifications.

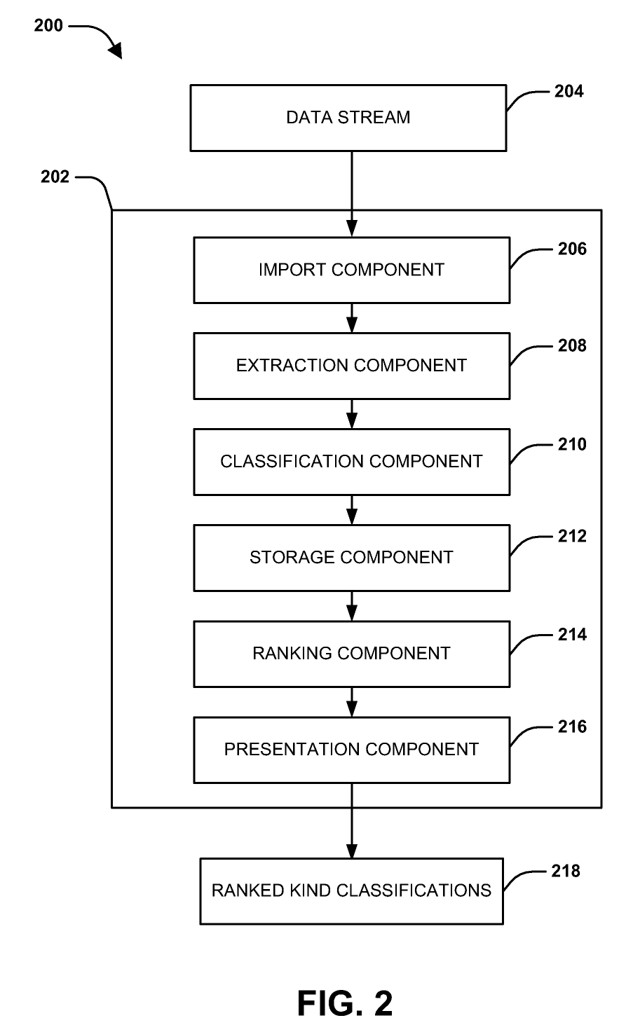

FIG. 2 illustrates an example 200 of a system 202 configured to create at least one semantic context of a data stream. The system 202 may comprise an import component 206, an extraction component 208, a classification component 210, and/or a presentation component 216. The system 202 may further comprise a storage component 212 and/or a ranking component 214.

The import component 206 may be configured to receive a data stream 204. The import component 206 may be configured to extract metadata from the data stream 204. The import component 206 may create a format table based upon the extracted metadata from the data stream 204. The import component 206 may create a work packet associated with the data stream 204 and/or the extracted metadata. It may be appreciated that the work packet may comprise the data stream 204, the extracted metadata, and/or other data used in processing the data stream 204 to create semantic contextual information. The import component 206 may be configured to remove non-semantic entities within the data stream 204 of the work packet. In one example, the data stream may comprise non-semantic HTML (e.g., advertisements, tags, scripts, etc.) which may be removed because they do not comprise useful information in creating semantic contextual information of the data stream 204. A modified version of the HTML may exist within the work packet based upon the removal.

The extraction component 208 may be configured to extract at least one feature from the work packet. In one example, the data stream may comprise text. Extracted features may comprise titles, paragraphs, phrases, recognized named entities, etc. In another example, features may be extracted and used to identify subjects related to the data stream. It may be appreciated that a subject may be a kind classification representing a broad topic relating to the data stream. The subjects and/or features may be used by the classification component 210 to create at least one kind classification. In yet another example, a list of entities within the data stream may be extracted as features and used by the classification component 210 to create at least one kind classification.

The classification component 210 may be configured to create at least one kind classification. The kind classification may comprise a confidence level of the classification, a timestamp, and/or the data stream associated with the kind classification. A kind classification may represent the semantic context of features within the data stream. A kind classification may be created based upon at least one feature corresponding to the kind classification (e.g., the extracted feature is a desired match to features of the kind classification). For example, the data stream 204 may comprise rectangular pixels representing an image of a car. The extraction component 208 may extract the features of a window, tire, door, etc. Using these features, the classification component 210 may create a car kind classification because the car kind classification may comprise the features of a window, tire, door, etc.

The classification component 210 may be configured to determine if at least one duplicate kind classification exists within the work packet. If a duplicate kind classification exists, then the classification component 210 may remove the duplicate kind classification from the work packet or revise the duplicate kind classification to create a revised duplicate kind classification within the work packet.

The storage component 212 may be configured to store at least one kind classification from the work packet into a persistent storage. The storage component 212 may index kind classifications within the persistent storage based upon textual, spatial, temporal, and/or other indexing techniques. The storage component 212 may be configured to create a schema associated with the indexed kind classifications.

The ranking component 214 may be configured to create a ranking set (e.g., ranked kind classifications 218) comprising an ordered vector of kind classifications based upon at least one user preference. For example, a user may express interest in bikes. Multiple kind classifications may be associated with bikes (e.g., current bike events, biking clubs, bike hardware reviews, biking stores, bike repair shops, etc.). The user may have a preference for biking clubs and current biking events, but may not be interested in a new bike and/or bike repairs. A ranking set may order these kind classifications based upon user's interests.

The presentation component 216 may be configured to present at least one kind classification and/or associated set of related data. The presentation component 216 may be configured to present the ranked kind classifications 218 from a ranking set. The ranked kind classifications 218 may be presented within a web browser, a window, a carousel, etc.

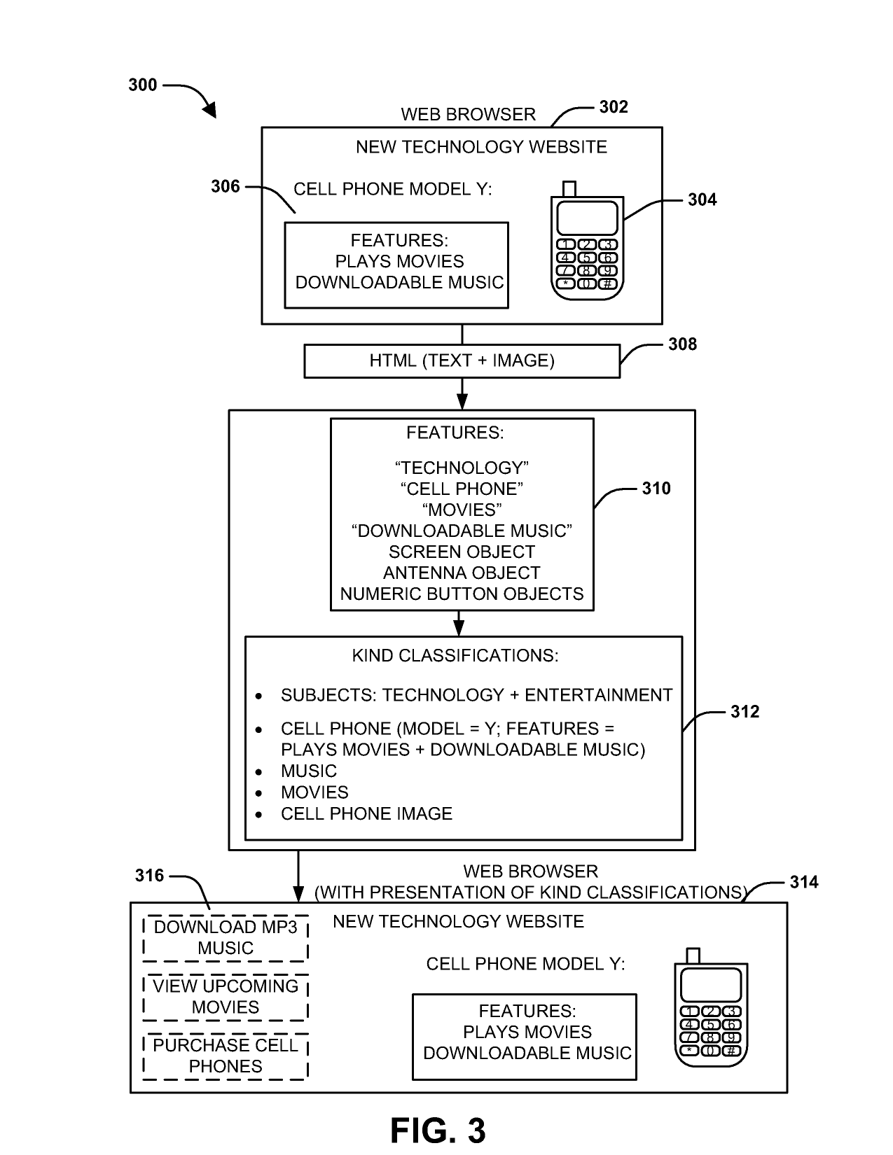

FIG. 3 illustrates an example 300 of creating at least one kind classification based upon a data stream comprising HTML representing an image and text of a webpage. In example 300, a web browser 302 presents a new technology website. The technology website comprises text 306 and an image 304 corresponding to a cell phone. HTML 308 comprising the textual information and the image data may be received. Upon receiving the HTML 308 (e.g., a data stream), a format table may be created based upon stripped metadata from the HTML 308. The format table may comprise additional information regarding the image and/or text within the HTML 308. Non-semantic entities may be removed from the HTML 308 (e.g., the new technology website may comprise advertisements which provide little semantic context).

A set of features 310 may be extracted from the HTML 308. For example, a screen object, an antenna object, and/or a numeric button object may be extracted as features from the image data. The words technology, cell phone, movies, and/or downloadable music may be extracted as features from the text. The features may be used to create a set of kind classifications 312. A subject (e.g., a kind classification corresponding to a topic) may be created within the set of kind classifications 312. For example, entertainment may be a subject derived from the features of movies and/or downloadable music. Technology may be a subject derived from the features of technology and/or cell phone.

The extracted features may be used to create kind classifications of music, movies, cell phone, and/or cell phone image. The cell phone may further comprise the features of what is the cell phone model and/or what are the features of the cell phone. The kind classifications and/or subjects may be stored within a persistent database, index, and/or associated with a schema.

The kind classifications may be presented through the web browser 314. For example, actions 316 associated with music, movies, and cell phone kind classifications may be presented. The user may be able to download MP3 music, view upcoming movies, purchase cell phones, and/or any other actions that may be associated with the kind classifications.

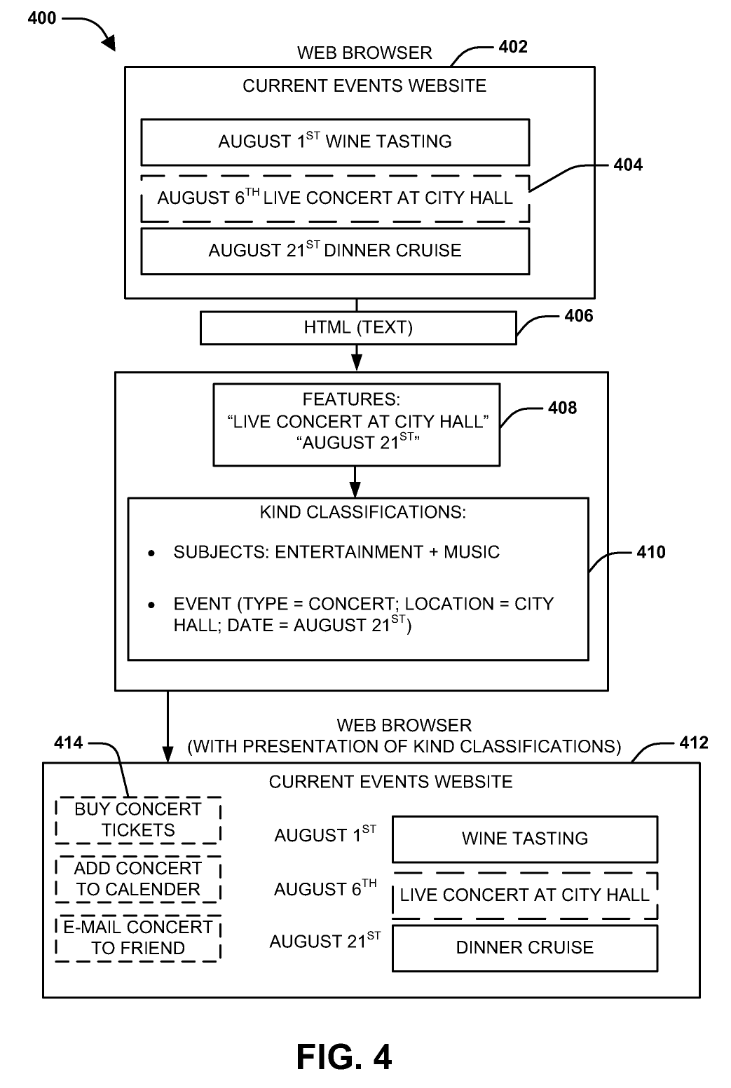

FIG. 4 illustrates an example 400 of creating at least one kind classification based upon a data stream comprising HTML representing text of a webpage. In example 400, a web browser 402 presents a current events website. The current events website may comprise information regarding a wine tasting, a live concert at city hall, a dinner cruise, and/or other information relating to current events. It may be advantageous to understand the semantic meaning of what information a user may interact with in the current events website. For example, it may be useful to understand that the user may have an interest in concerts. This allows additional related information about concerts and/or related actions to be presented to the user for a rich user experience (e.g., booking the concert, sharing the concert information with friends, adding information about the concert to the user's calendar, etc.).

Within the web browser 402, concert text 404 may be selected by a user. The concert text 404 may comprise the text “August 6^{th} Live Concert at City Hall”. HTML 406 (e.g., a data stream) representing the text may be received. The HTML 406 may be received by an import component configured to create at least one format table corresponding to the HTML 406. The format data and/or data stream may be used to create a work packet. The import component may remove non-semantic entities from the HTML within the work packet. An extraction component may extract at least one feature from the HTML within the work packet. For example, a set of features 408 may be extracted from the HTML. The set of features 408 may comprise a first text feature comprising the phrase “Live Concert at City Hall” and a second text feature comprising the phrase “August 21^{st}”.

A classification component may use the first text feature and/or the second text feature to create a set of kind classifications 410. For example, the set of kind classifications 410 may comprise an entertainment subject and a music subject which may have been derived from the text “Concert” within the feature “Live Concert at City Hall”. An event kind classification may be created derived from the text “Live Concert” and comprises additional information regarding the event based upon the first text feature (e.g., type and location) and/or the second text feature (e.g., date). A storage component may store the set of kind classifications within a persistent storage device (e.g., a data base), index the kind classifications, and/or project a schema associated with the kind classifications.

A presentation component may present the kind classifications through the web browser 412. For example, actions 414 relating to the event kind classification, the entertainment subject, and the music subject may be presented. The user may be able to buy concert tickets, add the concert to their calendar, and/or e-mail concert information to a friend.

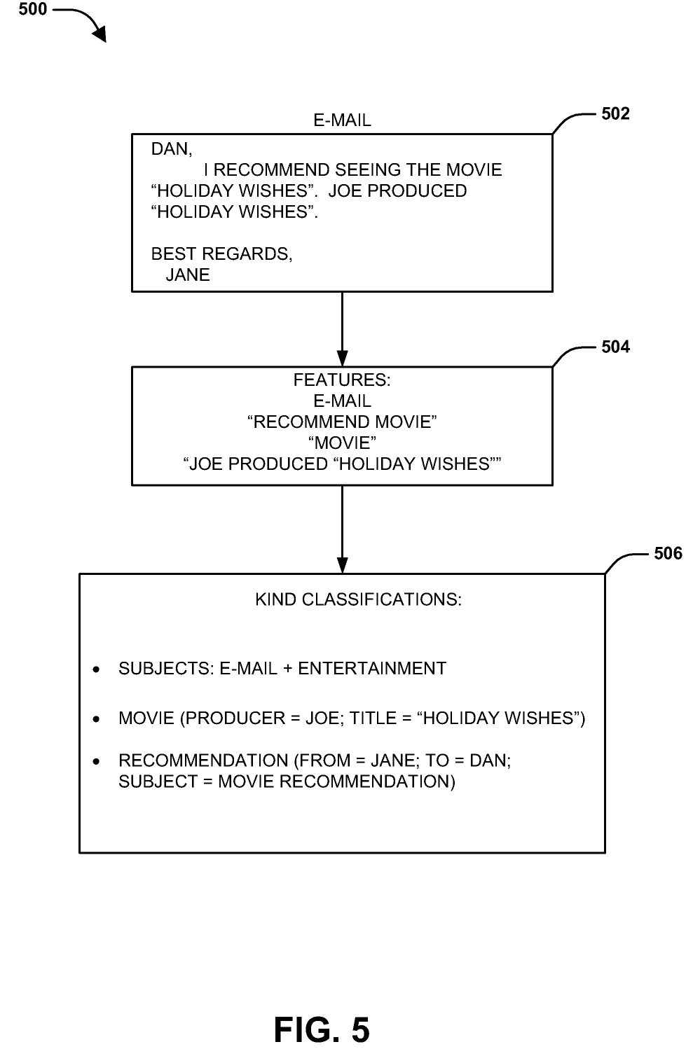

FIG. 5 illustrates an example 500 of creating at least one kind classification based upon a data stream comprising text within an e-mail 502. In one example, a user, Dan, receives an e-mail from Jane. The e-mail comprises a recommendation for Jane to see the movie “Holiday Wishes” produced by Joe. It may be useful to determine the context of the text within the e-mail, which may be difficult for a computer to accomplish. If the context of the e-mail can be determined, then additional information and/or actions may be presented to the user (e.g., information regarding the movie, other movies produced by Joe, storing the recommendation e-mail for later retrieve through a key word search, etc.). This may provide the user with a rich user experience compared to just reading the e-mail. One approach to determine the context of the e-mail is through the creation of kind classifications. The kind classifications may comprise semantic context of the email.

In example 500, a data stream comprising the text of the e-mail 502 may be received. A set of features 504 may be extracted from the data stream based upon an analysis of the text. For example, the text “recommend movie”, “movie”, and/or “Joe produced “Holiday Wishes”” may be features that may be used to create kind classifications having those features. It may be appreciated that many other features may be extracted.

A set of kind classifications 506 may be created based upon the set of features 504. For example, an e-mail subject and an entertainment subject may be created. A movie kind classification may be created comprising the contextual information that Joe is the producer and the title is “Holiday Wishes”. A recommendation kind classification may be created comprising the contextual information that Jane made the recommendation, Dan received the recommendation, and the recommendation was for a movie. The kind classifications may be used to suggest other movies produced by Joe, allow the purchase of tickets to “Holiday Wishes”, search for other recommendations, etc. The kind classifications may be stored within a database. It may be appreciated that many other kind classifications and/or subjects may be created based up the features extracted from the e-mail 502.

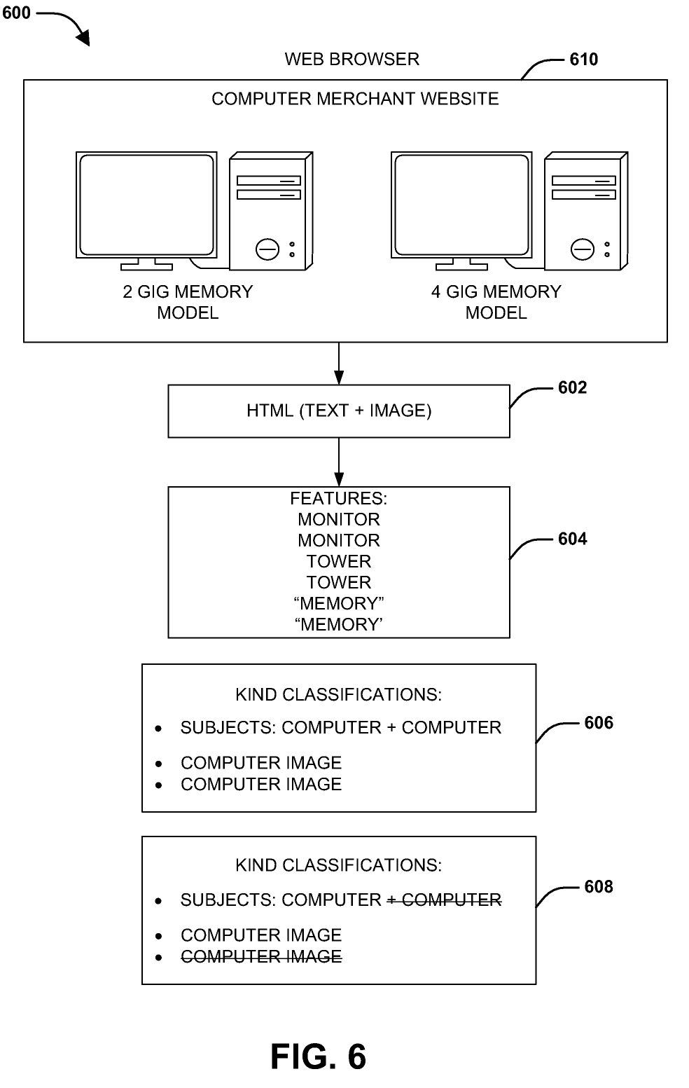

FIG. 6 illustrates an example 600 of removing at least one duplicate kind classification from a set of kind classifications. In example 600, a web browser 610 presents a computer merchant website. The computer merchant website may sell computer model with different amounts of memory (e.g., a 2 gig memory model and a 4 gig memory model). The computer merchant website may use a similar image for the 2 gig memory model and the 4 gig memory model.

A data stream may be received comprising HTML 602 representing the text of the computer merchant website and/or image data of the 2 gig and 4 gig memory models. A set of features may be extracted from the HTML 602. For example the 2 gig memory model image and the 4 gig memory model image may comprise recognizable monitor features and tower features within the images. The text “memory”, “computer”, and/or other text may be extracted as features.

A set of kind classifications 606 may be created based upon the features. For example, a “computer hardware” subject may be created based upon the “memory”, “computer”, “monitor”, and/or other related features. The subject “computer hardware” may indicate that the data stream (e.g., the website) concerns computer hardware. This identification may improve accuracy for processing and/or creating other kind classifications from the data stream. A computer image kind classification may be created based upon the monitor and/or tower features. The set of kind classifications 606 comprise duplicate kind classifications because duplicate features were extracted from the HTML 602. For example, the two computer images are similar and therefore may comprise similar features. Duplicate kind classifications may be removed or revised to improve efficiency. For example, one of the computer subjects and one of the computer image kind classifications are removed to create an updated kind classification set 608.

Kind classifications provide a technique for automated classification of user interactions, allowing improved guidance for users. The classification and guided user interaction may enrich a user's experience on content within the internet (e.g., WWW, existing devices, social networks, etc.). The kind classifications may represent meaningful patterns and categories describing the data a user generates and/or encounters in a semantic context. Based upon the kind classifications, additional information may be provided to the user to help guide the user to content and/or interactions the user may be interested in. A knowledge base may be created from the kind classifications, which may be drawn from to provide relevant information based upon a user's preferences. For example, a set of kind classifications may have been created concerning multiple e-mail recommendations for different movies. Upon the user expressing interest in searching for a movie to watch, the set of kind classifications may be ranked based upon the type of movie the user is looking to see. Then the recommendations within the e-mails may be presented to the user to help guide the user's decision. Furthermore, the user may perform actions corresponding to the kind classifications, allowing the user to preview and/or read reviews of these movies.

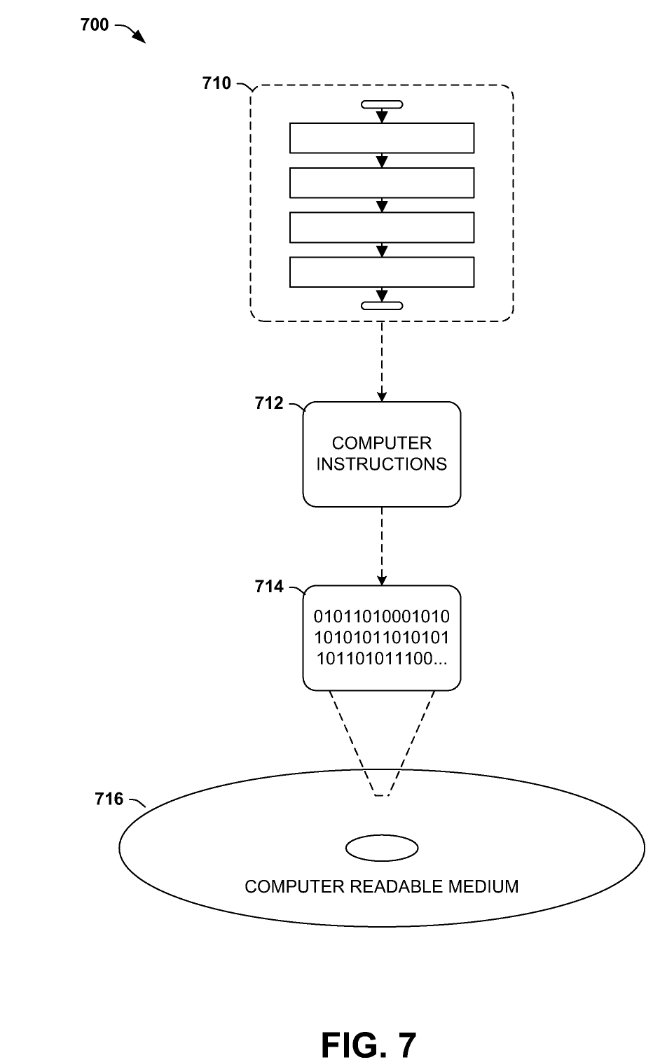

Still another embodiment involves a computer-readable medium comprising processor-executable instructions configured to implement one or more of the techniques presented herein. An exemplary computer-readable medium that may be devised in these ways is illustrated in FIG. 7, wherein the implementation 700 comprises a computer-readable medium 716 (e.g., a CD-R, DVD-R, or a platter of a hard disk drive), on which is encoded computer-readable data 710. This computer-readable data 710 in turn comprises a set of computer instructions 712 configured to operate according to one or more of the principles set forth herein. In one such embodiment 700, the processor-executable instructions 714 may be configured to perform a method, such as the exemplary method 100 of FIG. 1, for example. In another such embodiment, the processor-executable instructions 714 may be configured to implement a system, such as the exemplary system 200 of FIG. 2, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

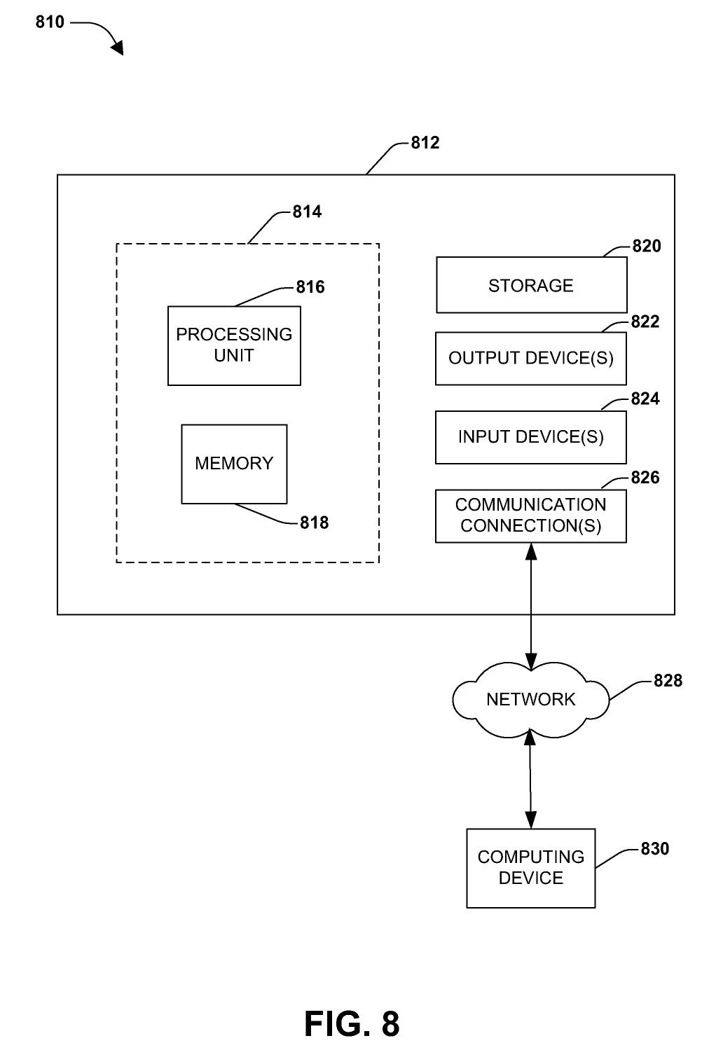

FIG. 8 and the following discussion provide a brief, general description of a suitable computing environment to implement embodiments of one or more of the provisions set forth herein. The operating environment of FIG. 8 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 8 illustrates an example of a system 810 comprising a computing device 812 configured to implement one or more embodiments provided herein. In one configuration, computing device 812 includes at least one processing unit 816 and memory 818. Depending on the exact configuration and type of computing device, memory 818 may be volatile (such as RAM, for example), non-volatile (such as ROM, flash memory, etc., for example) or some combination of the two. This configuration is illustrated in FIG. 8 by dashed line 814.

In other embodiments, device 812 may include additional features and/or functionality. For example, device 812 may also include additional storage (e.g., removable and/or non-removable) including, but not limited to, magnetic storage, optical storage, and the like. Such additional storage is illustrated in FIG. 8 by storage 820. In one embodiment, computer readable instructions to implement one or more embodiments provided herein may be in storage 820. Storage 820 may also store other computer readable instructions to implement an operating system, an application program, and the like. Computer readable instructions may be loaded in memory 818 for execution by processing unit 816, for example.

The term “computer readable media” as used herein includes computer storage media. Computer storage media includes volatile and nonvolatile, removable and non-removable media implemented in any method or technology for storage of information such as computer readable instructions or other data. Memory 818 and storage 820 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 812. Any such computer storage media may be part of device 812.

Device 812 may also include communication connection(s) 826 that allows device 812 to communicate with other devices. Communication connection(s) 826 may include, but is not limited to, a modem, a Network Interface Card (NIC), an integrated network interface, a radio frequency transmitter/receiver, an infrared port, a USB connection, or other interfaces for connecting computing device 812 to other computing devices. Communication connection(s) 826 may include a wired connection or a wireless connection. Communication connection(s) 826 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 812 may include input device(s) 824 such as keyboard, mouse, pen, voice input device, touch input device, infrared cameras, video input devices, and/or any other input device. Output device(s) 822 such as one or more displays, speakers, printers, and/or any other output device may also be included in device 812. Input device(s) 824 and output device(s) 822 may be connected to device 812 via a wired connection, wireless connection, or any combination thereof. In one embodiment, an input device or an output device from another computing device may be used as input device(s) 824 or output device(s) 822 for computing device 812.

Components of computing device 812 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 812 may be interconnected by a network. For example, memory 818 may be comprised of multiple physical memory units located in different physical locations interconnected by a network.

Those skilled in the art will realize that storage devices utilized to store computer readable instructions may be distributed across a network. For example, a computing device 830 accessible via network 828 may store computer readable instructions to implement one or more embodiments provided herein. Computing device 812 may access computing device 830 and download a part or all of the computer readable instructions for execution. Alternatively, computing device 812 may download pieces of the computer readable instructions, as needed, or some instructions may be executed at computing device 812 and some at computing device 830.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such features may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A system for creating contextual representations of a data stream through semantic interpretation, comprising:
an import component configured to:
receive a data stream;
extract metadata from the data stream;
create a work packet associated with the data stream and the extracted metadata;
an extraction component configured to:
extract at least one feature from the work packet;
a classification component configured to:
create at least one kind classification based upon at least one feature in the work packet, the kind classification comprising:
a confidence level of the classification;
a timestamp; and
the data stream associated with the kind classification; and
a presentation component configured to:
present at least one kind classification.

2. The system of claim 1, the import component configured to:
remove at least one non-semantic entity within the data stream in the work packet.

3. The system of claim 1, the classification component configured to:
determine whether at least one duplicate kind classification exists within the work packet; and
upon determining whether at least one duplicate kind classification exists perform at least one of:
remove the at least one duplicate kind classification from the work packet; and
revise the at least one duplicate kind classification to create a revised duplicate kind classification within the work packet.

4. The system of claim 1, comprising:
a storage component configured to:
store at least one kind classification from the work packet into a persistent storage; and
index at least one kind classification within the persistent storage based upon at least one of:
textual indexing;
spatial indexing; and
temporal indexing.

5. The system of claim 4, the storage component configured to:
create a schema associated with the at least one kind classification indexed within the persistent storage.

6. The system of claim 1, comprising:
a ranking component configured to:
create a ranking set comprising an ordered vector of kind classifications based upon at least one user preference.

7. The system of claim 1, the classification component configured to create at least one kind classification based upon external reference data.

8. The system of claim 1, the storage component configured to store at least one kind classification within a cloud based computing system.

9. The system of claim 1, the data stream comprising data associated with at least one of the following:
an e-mail,
text image,
text,
video,
audio,
unstructured data, and
structured data.

10. A method for creating contextual representations of a data stream through semantic interpretation, comprising:
receiving a data stream;
extracting metadata from the data stream;
extracting at least one feature from the data stream based upon the extracted metadata;
creating at least one kind classification based upon at least one feature, a kind classification comprising:
a confidence level of the classification;
a timestamp; and
the data stream associated with the kind classification; and
presenting at least one kind classification.

11. The method of claim 10, the receiving comprising:
removing at least one non-semantic entity with the data stream.

12. The method of claim 10, the classifying comprising:
determining whether at least one duplicate kind classification exists; and
upon determining whether at least one duplicate kind classification exists, performing at least one of:
remove the at least one duplicate kind classification; and
revise the at least one duplicate kind classification to create a revised duplicate kind classification.

13. The method of claim 10, comprising:
storing at least one kind classification in a persistent storage.

14. The method of claim 13, comprising:
indexing at least one kind classification within the persistent storage based upon at least one of:
textual indexing;
spatial indexing; and
temporal indexing.

15. The method of claim 14, comprising:
creating a schema associated with the at least one kind classification indexed within the persistent storage.

16. The method of claim 10, comprising:
creating a ranking set comprising an ordered vector of kind classifications based upon at least one user preference.

17. The method of claim 15, comprising:
presenting the ranking set within at least one of:
a web browser;
a window; and
a carousel.

18. The method of claim 13, comprising:
storing the persistent storage within a cloud based computing environment.

19. The method of claim 10, the receiving comprising:
receiving the data stream comprising data associated with at least one of the following:
an e-mail,
text image,
text,
video,
audio,
unstructured data, and
structured data.

20. A system for creating contextual representations of a data stream through semantic interpretation, comprising:
an import component configured to:
receive a data stream as a work packet;
remove at least one non-semantic entity within the data stream in the work packet;
create a format table based upon stripped metadata from the data stream; and
create a work packet associated with the data stream and the format table;
an extraction component configured to:
extract at least one feature from the work packet;
a classification component configured to:
create at least one kind classification based upon at least one feature in the work packet, the kind classification comprising:
a confidence level associated with the classification;
a timestamp; and
the data stream associated with the kind classification; and
determine whether at least one duplicate kind classification exists within the work packet; and
upon determining whether at least one duplicate kind classification exists perform at least one of:
remove the at least one duplicate kind classification from the work packet; and
revise the at least one duplicate kind classification to create a revised duplicate kind classification within the work packet;
a presentation component configured to:
present at least one kind classification from the work packet; and
a storage component configured to:
store at least one kind classification from the work packet in a persistent storage;
index at least one kind classification within the persistent storage based upon at least one of:
textual indexing;
spatial indexing; and
temporal indexing; and
create a schema associated with the at least one kind classification indexed within the persistent storage.
